(19) United States
(12) Patent Application Publication
(10) Pub. No.: US 2009/0266101 A1
(43) Pub. Date: Oct. 29, 2009

(54) DOMESTIC BEVERAGE DISPENSING APPARATUS COMPRISING AN ADSORBENT COOLING DEVICE

(75) Inventors: Eric Mark Sloot, Drachten (NL); Joldert Maria Boersma, Drachten (NL); Hugui Wang, Hoogeveen (NL); Marcelinus Johannus Maria Bruggeman, Hoogeveen (NL); Roland Van Straaten, Drachten (NL); Paulus Cornelis Duineveld, Drachten (NL); Johan Bernard Kuperus, Hoogeveen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/375,779

(22) PCT Filed: Jul. 17, 2007
(86) PCT No.: PCT/IB07/52840

§ 371 Date: Jan. 30, 2009

(30) Foreign Application Priority Data
Aug. 4, 2006 (EP) 06118431.3

(51) Int. Cl. F25B 17/08; B67D 5/62; F25B 21/02

(52) U.S. Cl. 62/389; 222/146.6; 62/3.2; 62/480

(57) ABSTRACT

beverage dispensing apparatus for enclosing and cooling a keg (1) containing a beverage, comprising means for guiding the beverage from the keg (1) to a dispending tap for controlling the beverage output from the dispensing apparatus. The apparatus comprises a cooling system provided with heat transfer means (4) being in direct thermal contact with the keg (1). The cooling system is provided with an adsorbent cooling device (3) comprising a liquid chamber (5) for containing and vaporizing a liquid working substance (8), and an adsorbent chamber (6) containing an adsorbent (9) for adsorbing the vaporized working substance. The liquid chamber (5) is connected through a control valve (12) with the adsorbent chamber (6).

### FIELD OF THE INVENTION

The invention is related to a beverage dispensing apparatus for enclosing and cooling a keg containing a beverage, comprising means for guiding the beverage from the keg to a dispending tap for controlling the beverage output from the dispensing apparatus, furthermore comprising a cooling system provided with heat transfer means being in direct thermal contact with the keg.

### BACKGROUND OF THE INVENTION

Beverage dispensing apparatus for commercial use are known for dispensing of draft beer in taverns and the like. Thereby, in general, the beer is cooled in a chiller while it is guided to the beer dispensing tap. Such draft beer dispensers are utilized in taverns where large volumes of beer are dispensed everyday, and such taverns have space available to store voluminous chillers. This is not the case for a domestic beer dispensing apparatus that is adapted to be placed on the countertop in a kitchen or on a table. For that reason, in a beer dispensing apparatus for domestic use, the beer is cooled while it is in the keg, before it is guided out of the keg to the beer dispensing tap of the apparatus. Such a domestic beer dispensing apparatus is disclosed in WO-A-2004/051163.

Although the invention is related to a beverage dispensing apparatus, i.e. an apparatus for dispensing any kind of beverage that has to be cooled down to a drinking temperature, hereinafter will be referred to a beer dispensing apparatus. However, other beverages can be treated in the same way.

In order to cool the keg containing beer, the keg can be placed for some time in a refrigerator before it is placed in the beer dispensing apparatus. Afterwards, the keg can be cooled while it is present in the beer dispensing apparatus in order to maintain its low temperature. For that purpose, the beer dispensing apparatus can be provided with a so called Peltier cooling device, being known in the art, whereby heat is absorbed at one junction and released at another junction of paired metals or semiconductors when electric current passes through these junctions.

Important advantages of the Peltier cooling device are the limited dimension of it and the fact that the Peltier cooling device does not make any noise when it is in use. However, such cooling device has only a limited cooling capacity, so that it takes a relative long time when the beer in the keg has to be cooled down from room temperature to the desired drinking temperature. Cooling down a keg containing 6 liter beer may take more than 10 hours when it is cooled down in a domestic beer dispensing apparatus from 23° C. to 3° C. For example, a compression cooling device could be used in order to cool down beer in a shorter period of time. However, to cool down the beer within a very short time, such as half an hour or so, would require a very powerful cooling device, and that would require a high supply of electric current, and large cooling device volume, which are disadvantages for a domestic beer dispensing apparatus.

### SUMMARY OF THE INVENTION

An object of the invention is a beverage dispensing apparatus for enclosing a keg containing a beverage, comprising a cooling system provided with heat transfer means being in direct thermal contact with the keg inside the dispensing apparatus, whereby the keg can be cooled down in the apparatus in a relative short period of time.

Another object of the invention is a beverage dispensing apparatus for enclosing a keg containing a beverage, comprising a cooling system for the keg whereby the beverage can be cooled down in a relative short period of time, without the need of relative high electric current supply to the beverage dispensing apparatus.

Another object of the invention is a beverage dispensing apparatus for enclosing a keg containing a beverage, comprising a cooling system for the keg whereby the beverage can be cooled down in a relative short period of time, without the need of a large cooling device volume.

Another object of the invention is a beverage dispensing apparatus for enclosing a keg containing a beverage, comprising a cooling system for the beverage whereby the beverage can be cooled down in a relative short period of time, and whereby the beverage can also be kept cool for a long time, and whereby the apparatus does not make noise when its cooling system is in use.

Another object of the invention is a beverage dispensing apparatus for enclosing a keg containing a beverage, whereby the keg can be cooled down and/or can be kept cool in the dispensing apparatus without any power supply to the beverage dispensing apparatus.

To accomplish with one or more of these objects, the cooling system is provided with an adsorbent cooling device comprising a liquid chamber for containing and vaporizing a liquid working substance, and an adsorbent chamber containing an adsorbent for adsorbing the vaporized working substance, whereby the liquid chamber is connected through a control valve with the adsorbent chamber. By making use of such adsorption cooling device, whether or not in combination with the use of a Peltier cooling device for additional cooling purposes, the beverage can be cooled down in the beverage dispensing apparatus in a relative short period, depending on the design even less than half an hour.

In a preferred embodiment, the beverage dispensing apparatus is a domestic beer dispensing apparatus. Experiences have proven that such beer dispensing apparatus meets all expectations.

The keg can be cooled by means of a thermal contact member at its lower side, whereby the keg rests on the contact member. Instead of that, or additional to that, the heat transfer means of the cooling system preferably comprise a thermal contact member for contacting at least a portion of the substantial cylindrical side wall of the keg, so that the heat can be transferred away from the keg in an effective and efficient way by means of the cooling system.

In a preferred embodiment, the adsorbent is zeolite and the working substance is water, to which additives may be added. Zeolite is a crystalline mineral having a regular lattice structure made of silicon and aluminum oxides. The lattice structure contains small vacancies in which water molecules can be adsorbed, whereby heat is released. Within the lattice the water molecules are exposed to strong field forces that bind the molecules in the lattice in a liquid-like phase. About 1.5 kg zeolite is required to adsorb 300 ml water, and that quantity of water is sufficient to cool down about 6 liter beer from 23° C. to 3° C. In a preferred embodiment, additives are added to the water to lower the freezing point of it, in order to speed-up the cooling process.

The principle of such adsorption cooling device, whereby a solid adsorbent adsorbs a working substance, is known; it is for example described in U.S. Pat. No. 6,820,441. The apparatus according to this publication is a kind of refrigerator, and in case the apparatus would be used for cooling a keg containing beer, there is no heat transfer means being in direct thermal contact with the keg, so that there is not the advantage of a short cooling period, as is the case in the apparatus according to the invention.

On the other hand, the use of an adsorption cooling device for cooling beer is for example described in U.S. Pat. No. 6,378,326. According to this publication, the keg contains the beer as well as the adsorption cooling device, so that beer can be dispensed directly from the keg after the cooling device has cooled down the beer to its drinking temperature. After all the beer is dispensed, the keg has to be returned to the factory in order to regenerate the cooling device and to refill the keg with beer.

In a preferred embodiment, regeneration means are present comprising a heater for heating the adsorbent in order to subtract working substance from the adsorbent in a desorption process. When the adsorbent is zeolite and the working substance is water, the water can be subtracted from the zeolite by heating the zeolite up to a temperature between 150° C. and 300° C.

In a preferred embodiment, the vaporized working substance can be condensed after the desorption process, whereby the regeneration means comprise a condensing device for condensing the working substance and comprise means for guiding the working substance from the adsorbent chamber to the liquid chamber. The working substance can be condensed in the liquid chamber or on its way to the liquid chamber. Such adsorbent cooling device is called a closed system, because the working substance stays in the system and is reused after regeneration.

In another preferred embodiment, after the desorption process the working substance is guided to the environment in its vaporized phase. Then, the liquid chamber has to be refilled with liquid working substance, for example water, in order to initiate a next cooling process by vaporization and adsorption of the working substance. Preferably, the apparatus comprises means for supplying gas into the keg, which means comprise a pump, which pump can be switched in a mode whereby it pumps gas out of the liquid chamber. After air is pumped out of the liquid chamber, the cooling process can take place.

In a preferred embodiment, the cooling system of the beverage dispensing apparatus is additionally provided with a Peltier cooling device for cooling the keg. Thereby, the keg can be cooled down in a short period of time to its low drinking temperature by means of the adsorption cooling device, while it can be maintained at that low temperature for a long period of time by making use of the Peltier cooling device. In case the beverage dispensing apparatus is used without the presence of electric power supply, for example during a picnic in a forest, the adsorption device system can keep the beer cold for a limited period of time, which period can be quite long in case the keg is cooled in a refrigerator before it is placed in the beer dispensing apparatus. Preferably, the Peltier cooling device as well as the adsorbent cooling device are both cooling the same thermal contact member for contacting at least a portion of the substantial cylindrical side wall of the keg.

In a preferred embodiment, the Peltier cooling device comprises a second contact member for contacting at least a portion of the bottom of the keg. Thereby, the adsorption cooling device cools the keg through its relative large cylindrical side wall, and the Peltier cooling device cools the keg through its bottom. In general, the fast cooling down process takes place while the keg is fully filled with a beverage, so that the heat transfer can be performed through the relative large side wall of the keg, and when the keg is only partly filled with the beverage, the beverage can be cooled through its bottom, which bottom is still in contact with the beverage when the keg is almost empty.

### BRIEF DESCRIPTION OF THE DRAWINGS

The invention will now be further elucidated by means of a description of embodiments of a domestic beer dispensing apparatus for enclosing and cooling a keg containing beer, comprising a cooling system provided with heat transfer means being in direct thermal contact with the keg, whereby reference is made to the drawing comprising diagrammatical figures, whereby:

FIG. 1 shows the principle of the apparatus according to the invention;

FIG. 2 shows the apparatus of FIG. 1 with additionally a Peltier cooling device;

FIG. 3 shows the apparatus including regeneration means;

FIG. 4 shows an apparatus for top loading of the keg;

FIG. 5 shows an apparatus for side loading of the keg; and

FIG. 6 shows an apparatus with more separate adsorption cooling devices.

The figures are very schematic representations, only showing parts that contribute to the elucidation of embodiments of the invention.

### DETAILED DESCRIPTION OF EMBODIMENTS

The figures do not show the complete beer dispensing apparatus, which apparatus is for example shown in the figures of WO-A-2004/051163. The figures show only schematically the keg 1 containing beer, which keg 1 is enclosed in the domestic beer dispensing apparatus, and the figures show parts of the cooling system for cooling the keg 1. The keg 1 is a substantially cylindrical container and has a central axis 2 and contains, for example, 6 liter beer.

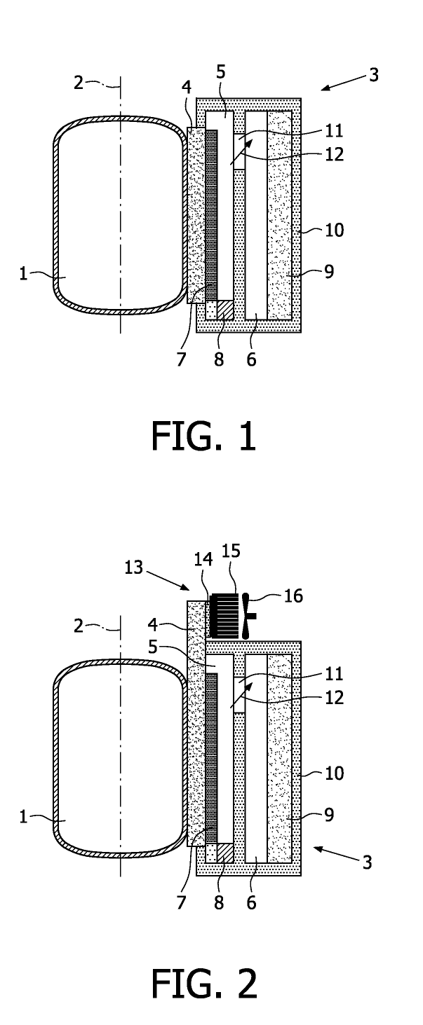

FIG. 1 shows the working principle of an adsorption cooling device 3 in a domestic beer dispensing apparatus according to the invention. The heat transfer means of the adsorbent cooling device 3 is a contact member 4 that has thermal contact with the substantial cylindrical side wall of the keg 1. The material of the contact member 4 is for example aluminum, a thermal conductive polymer, or graphite. The adsorption cooling device 3 is provided with a liquid chamber 5 and an adsorbent chamber 6. The liquid chamber 5 is bordered by the thermal contact member 4, and a sheet 7 of material that absorbs water is attached against the contact member 4. The material 7 can be, for example, non-woven glass fiber or mineral fiber material and is glued or stretched over the contact member 4. A certain quantity of water 8 is in the liquid chamber 5, which water 8 can be absorbed in sheet 7 and/or is present on the bottom of the liquid chamber 5.

The adsorbent chamber 6 contains a quantity of zeolite 9 that is attached to the outer wall 10 of the adsorbent chamber 6 in order to create a large interface between the surface of the zeolite 9 and the gas (vaporized water) in the adsorbent chamber 6. Furthermore, the outer wall 10 can transfer heat to the environment, which heat is generated in the zeolite 9 during the adsorption of vaporized water.

Between the liquid chamber 5 and the adsorbent chamber 6 is an opening 11, which opening 11 can be opened and closed by means of a control valve 12, which control valve 12 is schematically indicated by an arrow. The control valve 12 is controlled by a control system (not shown in the figures) so that it can be set in any desired open position. Before the cooling process starts, the valve 12 is in the closed position and air is removed from the liquid chamber 5 and the adsorbent chamber 6, so that the liquid chamber 5 contains water and vaporized water, and there is vacuum, or almost vacuum, in adsorbent chamber 6.

To start the cooling process, the control valve 12 is opened, so that the vaporized water can move through the opening 11 from the liquid chamber 5 to the adsorbent chamber 6, where it will be adsorbed in the zeolite 9. Thereby, the liquid water in the sheet 7 vaporizes, so that the sheet 7, and the thermal contact member 4, will be cooled down. When the outer surface of the sheet 7 is cooled down to the freezing temperature of the water, the vaporization will decrease, so that the temperature of the sheet 7 will remain near the freezing temperature of the water when the control valve 12 is kept in the complete open position. By controlling the valve 12, the vaporization of the water 8, and thereby the temperature of the contact member 4 can be adjusted to any desired temperature above the freezing temperature of the water.

To cool down a keg 1 containing 6 liter beer from 23° C. to 3° C., about 1.5 kg zeolite 9 and about 300 ml water 8 is sufficient. In order to keep the beer at its drinking temperature, more zeolite 9 and more water 8 has to be present, depending on the period of time that the beer has to be maintained on its drinking temperature. However, in order to keep the keg 1 at a low temperature, also additional cooling means, such as a Peltier cooling device, can be present, so that the beer can be kept cool during an indefinite long period of time.

FIG. 2 shows schematically an apparatus, whereby, additional to the adsorbent cooling device 3 that is elucidated above, a Peltier cooling device 13 is present. The Peltier cooling device 13 comprises a Peltier element 14, a heat sink 15 and a fan 16 for cooling the heat sink 15. The Peltier element 14 is attached to the thermal contact member 4 in order to cool down the contact member 4. Thereby, the contact member 4 can be cooled down by means of the adsorbent cooling device 3 as well as by means of the Peltier cooling device 13.

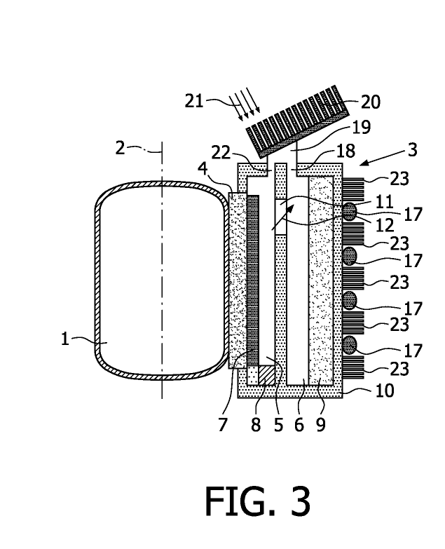

FIG. 3 shows the apparatus of FIG. 1 including regeneration means for regenerate the adsorbent cooling device 3, so that the cooling down process, as described above, can be repeated again and again. After the water 8 is vaporized and adsorbed by the zeolite 9, the zeolite 9 will be heated by means of the electric heating members 17 to a temperature between 150° C. and 300° C., whereby the adsorbed water will escape from the zeolite 9. Thereby, the control valve 12 is closed, so that the vaporized water will leave the adsorbent chamber 6 through opening 18 to a condensing chamber 19. There, the water will condense at the back side of heat sink 20, which heat sink 20 may be have a forced air cooling, as is indicated by arrows 21. The condensed water will leave the condensing chamber 19 through opening 22 and will arrive in the liquid chamber 5. After all the water has left the adsorbent chamber 6, the openings 18 and 19 can be closed, so that a next cooling process can be started by opening control valve 12. The outer side of the outer wall 10 of the adsorbent chamber 6 is provided with a number of heat sinks 23, in order to cool down the zeolite afterwards and to keep it at a temperature below 150° C. when the adsorption process takes place.

The adsorbent cooling device 3, as is shown in FIG. 3, is a so called closed adsorbent system, whereby the working substance (water) stays in the system and is reused after the regeneration operation. The adsorbent cooling device 3 can also be an open adsorbent system. Thereby, the zeolite 9 is regenerated whereby the desorbed water vaporizes in the air of the environment. The zeolite 9 can be heated while it is in the adsorbent chamber 6, but it can also be taken out of the adsorbent chamber 6 and placed in a domestic or industrial oven in order to heat it. Before the adsorption process is started again, the liquid chamber 5 has to be filled with a prescribed quantity of water, and air has to be pumped out of the liquid chamber 5 and the adsorbent chamber 6. In case the beer dispensing apparatus is provided with a pump for supplying gas into the keg in order to driving out the beer, then the same pump can be used for pumping air out of both chambers 5,6.

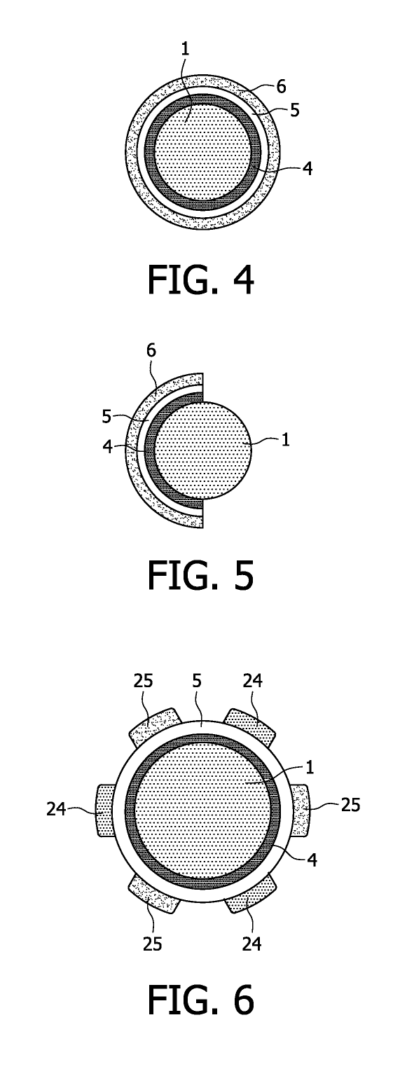

FIGS. 4, 5 and 6 are schematic horizontal cross sections of the apparatus as shown in FIG. 1. FIG. 4 represents a top loader, i.e. an apparatus whereby the keg 1 is placed in the apparatus from above. Thereby, the thermal contact member 4 can surround the keg 1 completely. FIG. 5 represents a side loader, i.e. an apparatus whereby the keg 1 is placed in the apparatus from a side. Thereby, the thermal contact member 4 can only surround the keg 1 partly, and an insulating door (not shown) can surround the remainder part of the keg 1. FIG. 6 represents a top loader, whereby six separate adsorbent chambers 24,25 are located around the liquid chamber 5. Thereby, the zeolite in the three adsorbent chambers 24 can be regenerated, while the zeolite in the other three adsorbent chambers 25 adsorb vaporized water from the liquid chamber 5. This figuration enables a continue cooling of the keg by means of the adsorption process.

The embodiments of the domestic beverage dispensing apparatus as described above are only examples of apparatus according to the invention; many other embodiments are possible.

1. A beverage dispensing apparatus for enclosing and cooling a keg containing a beverage, comprising means for guiding the beverage from the keg to a dispending tap for controlling the beverage output from the dispensing apparatus, furthermore comprising a cooling system provided with heat transfer means being in direct thermal contact with the keg, characterized in that the cooling system is provided with an adsorbent cooling device comprising a liquid chamber for containing and vaporizing a liquid working substance, and an adsorbent chamber containing an adsorbent for adsorbing the vaporized working substance, whereby the liquid chamber is connected through a control valve with the adsorbent chamber.

2. An apparatus as claimed in claim 1, characterized in that the heat transfer means of the cooling system comprise a contact member for contacting at least a portion of the substantial cylindrical side wall of the keg.

3. An apparatus as claimed in claim 1, characterized in that the adsorbent is zeolite and the liquid working substance is water.

4. An apparatus as claimed in claim 3, characterized in that additives are added to the water in order to lower the freezing point.

5. An apparatus as claimed in claim 1, characterized in that regeneration means are present comprising a heater for heating the adsorbent in order to subtract working substance from the adsorbent.

6. An apparatus as claimed in claim 5, characterized in that the regeneration means comprise a condensing device for condensing the working substance and means for guiding the working substance from the adsorbent chamber to the liquid chamber.

7. An apparatus as claimed in claim 1, characterized by means for supplying gas into the keg comprising a pump, which pump can be switched in a mode whereby it pumps gas out of the liquid chamber.

8. An apparatus as claimed in claim 1, characterized in that the cooling system of the beverage dispensing apparatus is additionally provided with a Peltier device for cooling the keg.

9. An apparatus as claimed in claim 8, characterized in that the Peltier device as well as the adsorbent cooling device are both cooling the same contact member for contacting at least a portion of the substantial cylindrical side wall of the keg.

10. An apparatus as claimed in claim 8, characterized in that the Peltier cooling device comprises a second contact member for contacting at least a portion of the bottom of the keg.
